(19) United States
(12) Patent Application Publication
(10) Pub. No.: US 2003/0230190 A1
(43) Pub. Date: Dec. 18, 2003

(54) Apparatus for surface control of a sub-surface safety valve

(76) Inventor: Neil Irwin Douglas, North Somerset (GB)

Correspondence Address: James E.Bradley, BRACEWELL & PATTERSON, L.L.P., P.O. Box 61389, Houston, TX, 77208-1389, US

(21) Appl. No.: 10/458,120

(22) Filed: Jun. 10, 2003

(30) Foreign Application Priority Data
Jun. 14, 2002 (GB) 0213733.9

(51) Int. Cl. F15B 11/08

(52) U.S. Cl. 91/454

(57) ABSTRACT

Apparatus for surface control of a sub-surface safety valve set within the production tubing of a drilling well, the apparatus comprising a hydraulic actuator for opening the sub-surface safety valve, a control line for supplying hydraulic control fluid to the actuator, a first control valve for controlling the supply of hydraulic fluid to the control line, a non-return valve in the control line path, between the actuator and the control valve, for preventing any contaminants entering the hydraulic fluid at the actuator from reaching the first control valve by migration up the control line, and an exhaust line connected to the actuator and control line and an associated second control valve enabling flushing of fluid from the actuator and control line.

### RELATED APPLICATIONS

This application claims the benefit of United Kingdom Patent Application No. 0213733.9, filed on Jun. 14, 2002, which hereby is incorporated by reference in its entirety.

### BACKGROUND OF THE INVENTION

1. Technical Field of the Invention

The present invention relates to an apparatus for surface control of a sub-surface safety valve set within the production tubing of a drilled well. The well may be a land based or a sea-bed based well and in the latter case the control is exercised from the surface of the sea bed.

2. Description of the Prior Art

Surface Controlled Sub-surface Safety Valves (SCSSVs) are normally set within production tubing of a well at a depth of between 200 and 600′ (ca. 60-180 metres) below the wellhead. FIG. 1 illustrates diagrammatically a known apparatus for controlling an SCSSV in the production tubing of an undersea well. This known apparatus comprises an SCSSV hydraulic actuator 1, a control system 2 positioned on a well tree 4 on the surface of the sea bed above the well head and a single hydraulic control line 3, typically a ¼″ (0.64 cm) hydraulic line, running from the control system 2, through the tree and tubing hanger 4 and down the production tubing (not shown) to the SCSSV actuator 1. The SCSSV actuator is controlled to be opened by switching of the control line input to a pressurised hydraulic supply 5 for the control system 2 and closed by reducing the hydraulic pressure in the line by connecting the control line 3 to a hydraulic return system 6. This switching function is carried out by an electrically controlled Directional Control Valve (DCV) 7. A pressure sensor 8 is provided to monitor the pressure in the control line 3.

The SCSSV actuator 1 switching volume in such systems is typically only a few cubic inches (say 20 ccs or so) of hydraulic fluid, which means that there is little fluid movement in the hydraulic control line when the actuator 1 is operated. SCSSV operation is also very infrequent, with pressure continually being applied to the fail-safe actuator in order to keep the SCSSV in the open position. This means that the hydraulic fluid in line 3 normally remains fairly stagnant.

Should a seal failure occur within the SCSSV, this can result in fluids from the well bore getting into the hydraulic supply control line 3 for the SCSSV. Where these fluids from the well bore are hydro-carbon based, as would be the case in an oil well installation, there is then the potential for gas and liquid hydro-carbons to migrate up the hydraulic line 3 into the SCSSV control system 2, and from there via the DCV into other hydraulic systems of the wellhead control system. Since hydrocarbons can be corrosive and detrimental to the control system operation, this has in the past lead to situations where contaminated hydraulic fluid has severely damaged other, often highly expensive, system components.

Because of the single control line 3 and low fluid supply actuating volumes, it is not possible to flush contaminated fluid from the control line in the system shown in FIG. 1, nor is it possible to replace the fluid in the line while the SCSSV is in operation.

One solution to the problem presented by contaminated hydraulic fluid is to provide a second hydraulic line as an exhaust line to allow contaminated hydraulic fluid to be flushed from the system. Such a known apparatus is shown diagrammatically in FIG. 2, in which the same references of FIG. 1 are used for the parts in this figure which are the same as or which correspond to parts of FIG. 1. In this apparatus, an exhaust line 9 is connected at one end, through a T formation union 10, to the hydraulic supply line 3 adjacent the SCSSV actuator 1 and, at its other end, connects to a second electrically controlled DCV 11. DCV 11 can switch the exhaust line 9 from a closed off position to a vent position and vice versa. In the vent position the exhaust line 9 is connected to a vent 12 through DCV 11.

For normal operation of the SCSSV actuator 1, the exhaust line 9 is closed off from the vent 12 outlet and the opening and closing of the SCSSV is carried out using DCV 8 to control the hydraulic pressure in control line 3, in the same way as in FIG. 1. When, however, it is desired to flush the system, DCV 8 is set to receive the pressurised hydraulic supply input and DCV 11 is set to connect exhaust line 9 to the output vent 12, so that fluid flows from the hydraulic supply 5 through DCV 8, control line 3, T union 10, exhaust line 9 and DCV 11 to the vent 12.

With the apparatus shown in FIG. 2, if operation of the actuator 1 is not to be interfered with, it is important to ensure, when flushing the system, that sufficient hydraulic pressure is maintained at the actuator 1 to ensure that SCSSV operation is not lost—the minimum pressure being a function of the tubing (well) pressure. If the supply pressure drops below this minimum pressure during the flushing operation (as a result of the fluid flow), then there is always a danger that an un-commanded closure of the SCSSV may occur. Thus, in order to prevent the supply pressure dropping below a predetermined minimum level, it may be necessary to use a restrictor 13, which is, typically, fitted at the vent outlet of DCV 11. A pressure sensor 14 is provided to monitor the pressure in the exhaust line 9.

However, with this apparatus, between flushing sessions there is still the possibility of hydro-carbon contamination reaching DCV 7 and possibly causing some damage to the control system.

### SUMMARY OF THE INVENTION

According to the present invention, there is provided apparatus for surface control of a sub-surface safety valve set within the production tubing of a drilled well, the apparatus comprising a hydraulic actuator for opening the sub-surface safety valve, a control line for supplying hydraulic control fluid to the actuator, control valve means for controlling the supply of hydraulic fluid to the control line, a non-return valve in the control line path, between the actuator and the control means, for restricting any contaminants from entering the hydraulic fluid at the actuator from reaching the control valve means by migration up the control line, and an hydraulic fluid exhaust means connected to the actuator and control line for enabling flushing of fluid from the control line.

Such a configuration allows hydraulic fluid to be vented upon closure of the SCSSV, thereby replacing some fluid in the control line during normal closure operation of the valve. It further encourages any gaseous or liquid hydro-carbons entering the system to migrate to a dedicated “vent” port rather than back up into the control system. Optionally, the apparatus may further comprise means for restricting the rate at which hydraulic fluid is vented from the exhaust line such that, during the flushing of fluid via the control line, sufficient hydraulic pressure for actuator operation is maintained. Such a configuration permits flushing of fluid from the actuator during normal operation without accidental closure of the SCSSV, as previously described.

### BRIEF DESCRIPTION OF THE DRAWINGS

Embodiments of the invention will now be described, by way of example, with reference to the accompanying drawings, in which:

FIGS. 1 & 2, as described above, diagrammatically illustrate known apparatus for controlling SCSSV actuators; and

FIG. 3 diagrammatically illustrates an apparatus for surface control of a sub-surface safety valve according to the present invention, with those parts which are the same as or correspond to parts used in the known arrangements having the same references.

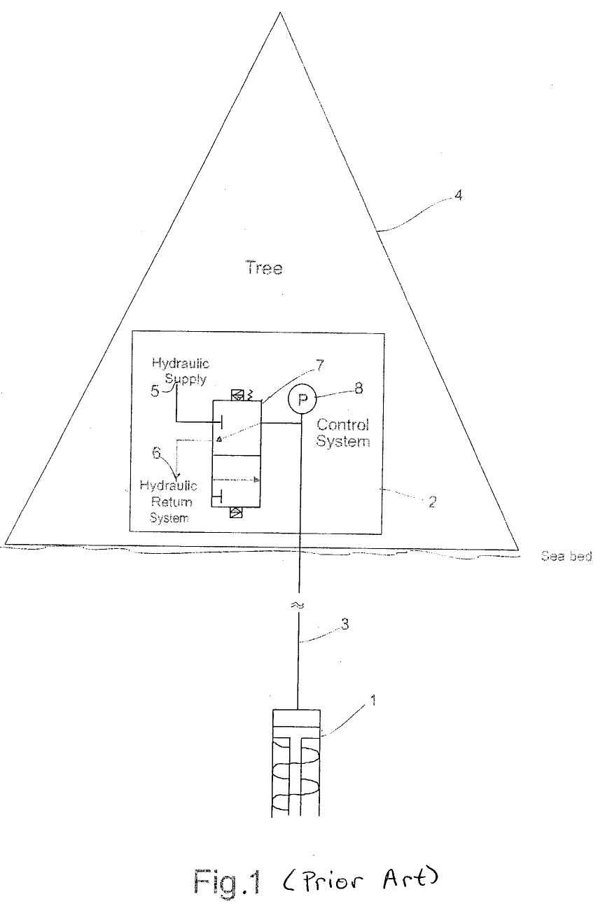

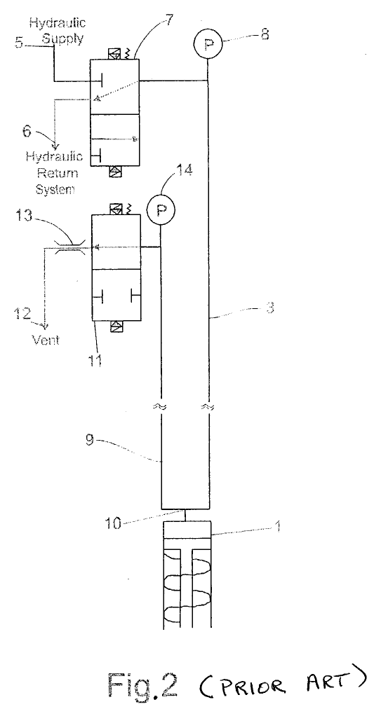

### DETAILED DESCRIPTION OF THE PREFERRED EMBODIMENT

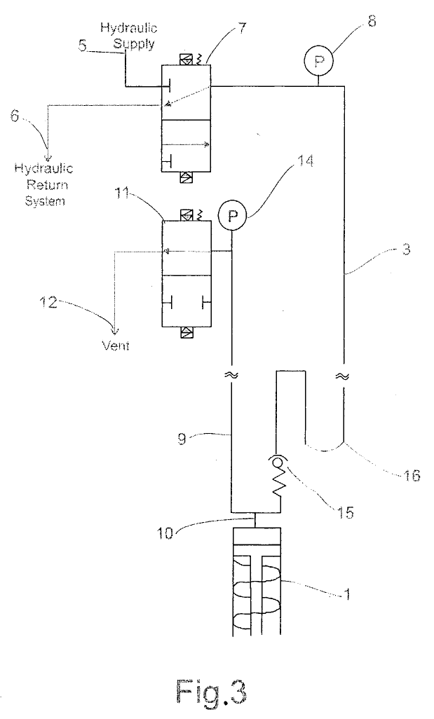

The apparatus shown in FIG. 3 comprises, an SCSSV hydraulic actuator 1 for operating an SCSSV (not shown), a first DCV 7, and a hydraulic fluid control line 3 for feeding pressurised hydraulic control fluid from a hydraulic supply 5 via DCV 7 to the actuator 1. DCV 7 is also coupled to a hydraulic return system 6 and can thus switch the connection to the control line 3 between the supply 5 and the return system 6. A non-return valve 15 is fitted in the hydraulic fluid control line 3 towards the actuator 1 end of the line. An exhaust line 9 is connected at a T union 10 to the control line 3, between the non-return valve 15 and the actuator 1 and its other end is connected to a second DCV 11 which in turn has an output port connected to an exhaust vent 12. The T union 10 should be as close as possible to the actuator 1. If, however, the actuator has two ports connecting to its operating chamber, the non-return valve 15 output can be connected directly to one port and the exhaust line 9 directly to the other port.

The apparatus further comprises pressure sensors 8 and 14, in order to monitor the pressure levels of the control line 3 and the exhaust line 9 respectively, and the control line 3 is also provided with a trap 16, fitted upstream of the non-return valve 15.

Control operation of the actuator 1 is similar to that of the known arrangement of FIG. 2. However, in this arrangement, the presence of the non-return valve 15 in control line 3 restricts contaminated fluid, from the actuator 1, from migrating back up the control line 3 and contaminating the hydraulic supply. This non-return valve may be of any suitable type. For example, the valve may be of the ball valve type comprising a spring or other resilient member which biases the valve towards its closed position, the biassing action being overcome when the fluid pressure upstream of the valve is greater than biassing and the fluid pressure downstream of the valve. The trap 16 serves to retain certain impurities in the hydraulic fluid, thus preventing them from entering the SCSSV actuator 1.

A specific flushing operation of the apparatus can be carried out as follows. With DCV 11 in the open position (i.e. in the vent position) DCV 7 is set to the hydraulic supply position allowing hydraulic fluid to pass to the SCSSV actuator 1 via the trap 16 and the check valve15, exhausting gas and contaminated hydraulic fluid via DCV 11 to the vent. Opening of the DCV 11 to the vent position will also cause the actuator 1 to close unless the control pressure is sufficiently high and the fluid flow restricted (for example using a restrictor 13 as in the FIG. 2 arrangement) so as to retain sufficient pressure in the actuator 1 control chamber. When the system is considered suitably flushed, DCV 11 is moved to the closed off position (i.e. away from the vent 12 position), causing the hydraulic actuator 1 to open the SCSSV.

In normal control operation, when release of actuator 1 is required to close the fail-safe SCSSV, DCV 7 is switched to the hydraulic return system 6 (i.e. disconnected from the hydraulic source 5) followed by DCV 11 being switched to vent, causing gas and contaminated fluid to be flushed up the exhaust line. Only a small amount of fluid is exhausted around 2 cubic inches (say 30 to 35 ccs) in this manner in each operation as compared with the approximately 400 cubic inches (6550 ccs) in the control line. For this reason the T union should be as close to the actuator as possible. A bifurcated union could also be used, with a single internally split port connected to the actuator control port and separate ports for the control and exhaust lines but preferably a two port actuator is used with separate control and exhaust ports. Using the latter causes the actuator chamber to be exhausted of contamination with normal valve operation.

Thus, in the embodiment shown, some flushing of the actuator hydraulic system is achieved every time the SCSSV actuator 1 is operated thus helping to avoid build up of stagnant and contaminated hydraulic fluid. In the event of failure of the non-return valve, the SCSSV actuator will still operate as normal, though the benefits of preventing contamination getting back up the control line will be lost.

As indicated above, an exhaust flow restrictor 13 may be incorporated, as in FIG. 2, in which case the aforementioned flushing mode of operation would be modified as follows. With DCV 11 in the open position (i.e. in the vent position) DCV 7 is set to the hydraulic supply position allowing hydraulic fluid to pass to the SCSSV actuator 1 via the trap 16 and the check valve 15, exhausting gas and fluid via DCV 11 to the vent 12. Due to the presence of the restrictor 13, the flushing process does not reduce the pressure sufficiently to allow the actuator 1 to close but keeps the pressure high so that the hydraulic actuator1 keeps open the SCSSV. When the system is considered suitably flushed, DCV 11 is moved to the closed position (i.e. not to vent). Should the system need to be flushed further at a later stage, this can be achieved without closing the SCSSV by simply returning DCV 11 to the open position. When release of the actuator is required, to close the fail-safe SCSSV, DCV 7 is switched to the hydraulic return system (i.e. disconnected from the hydraulic source) followed by DCV 11 being switched to vent, causing the fluid from the exhaust line to be flushed to the vent.

The control line is connected to the hydraulic return 6 so as to relieve pressure in the control line 3. If this were not to be done there is a risk that residual pressure in the pipe (which may have expanded under the hydraulic control pressure) might operate the SCSSV, particularly with a restrictor 13 in the exhaust path. DCV 7, together with the return valve 15, provides isolation of the SCSSV hydraulic system from the rest of the hydraulic system as well as providing pressure relief in the control line as explained above.

The incorporation of the non-return valve enables the pressure monitoring of the exhaust line with pressure sensor 14 to detect a leaking actuator. After the SCSSV has been closed, by switching DCV 7 to return 6 and DCV 11 to exhaust 12, subsequently returning DCV 11 to the closed off position should result in the pressure in the exhaust line staying constant. If, however, the pressure is sensed to be rising this would indicate a leaking actuator permitting ingress of fluid and gas from the well which cannot escape, because of the non return valve 15 and closed off DCV 11, and causes the pressure rise. Pressure monitoring may be done by human observation or by monitoring equipment.

The foregoing broadly describes the present invention, without limitation. Variations and modifications as will be apparent to those of ordinary skill in this art are intended to be comprised within the scope of this application and subsequent patents. For example, while the invention has been described with reference to an Electro-Hydraulic Subsea Control system (i.e. with electrically controlled DCVs and hydraulically controlled SCSSV actuator 1) and to a sea bed installation, the principles and concepts are just as applicable to a direct hydraulic control system, or to a land based well.

Also, control means different from thee DCVs that are shown could be used. For example, instead of two DCVs it may be possible to use a single three position version.

1. Apparatus for surface control of a sub-surface safety valve set within the production tubing of a drilled well, the apparatus comprising a hydraulic actuator for opening the sub-surface safety valve, a control line for supplying hydraulic control fluid to the actuator, control valve means for controlling the supply of hydraulic fluid to the control line, a non-return valve in the control line path, between the actuator and the control valve means, for preventing any contaminants entering the hydraulic fluid at the actuator from reaching the control valve means by migration up the control line, and an hydraulic fluid exhaust means connected to the actuator and control line for enabling flushing of fluid from the control line.

2. Apparatus according to claim 1, wherein the actuator is provided with an exhaust outlet and a control inlet, to which are connected respectively the exhaust and control lines, such that connection between the lines is via the actuator.

3. Apparatus according to claim 2, wherein the non-return valve is provided at the actuator control line inlet.

4. Apparatus according to claim 1, wherein the connection between the exhaust means and the control line is via two arms of a T junction, which has its remaining arm connected to the actuator.

5. Apparatus according to claim 1, wherein the apparatus further comprises means for restricting the rate at which hydraulic fluid may be exhausted such that, during the flushing of the fluid from the control line, a sufficient hydraulic pressure for actuator operation of the sub-surface valve is maintained.

6. Apparatus according to claim 1, wherein the control line includes a trap to restrict impurities in the hydraulic fluid from entering the actuator.

7. Apparatus according to claim 1, wherein the hydraulic fluid exhaust means comprises an exhaust line, connected to the actuator and control line, an exhaust vent and exhaust control valve means for controlling the connection and disconnection of the exhaust line from the exhaust vent.

8. Apparatus according to claim 1, including means for monitoring the pressure at the exhaust means.

9. A method of detecting a leaky actuator in the use of apparatus according to claim 8, including the steps of:
closing the exhaust means from venting hydraulic fluid;
removing switching control pressure from the sub-surface safety valve control line; and
monitoring the pressure at the exhaust means to determine whether it is rising or substantially constant.
